(19) United States
(12) Patent Application Publication
(10) Pub. No.: US 2004/0139086 A1
(43) Pub. Date: Jul. 15, 2004

(54) Method for providing internet addresses that contain special characters

(76) Inventor: Laszlo Hasenau, Bochum (DE)

Correspondence Address: HENRY M FEIEREISEN, LLC, 350 FIFTH AVENUE, SUITE 4714, NEW YORK, NY, 10118, US

(21) Appl. No.: 10/468,815

(22) PCT Filed: Feb. 21, 2002
(86) PCT No.: PCT/DE02/00632

(30) Foreign Application Priority Data
Feb. 28, 2001 (DE) 101 10 240.2

(51) Int. Cl. G06F 17/00

(52) U.S. Cl. 707/100

(57) ABSTRACT

The invention relates to a method for providing internet addresses that contain special characters. When an internet address is called up by a user on a computer, a first domain Name Server (DNS) is contacted. Said server is associated with at least one further DNS to which an internet protocol address that cannot be identified by the first DNS or only partially is forwarded decrypted by analyzing a sequential relational operation and transferred back to the user as a known numeric key (IP address).

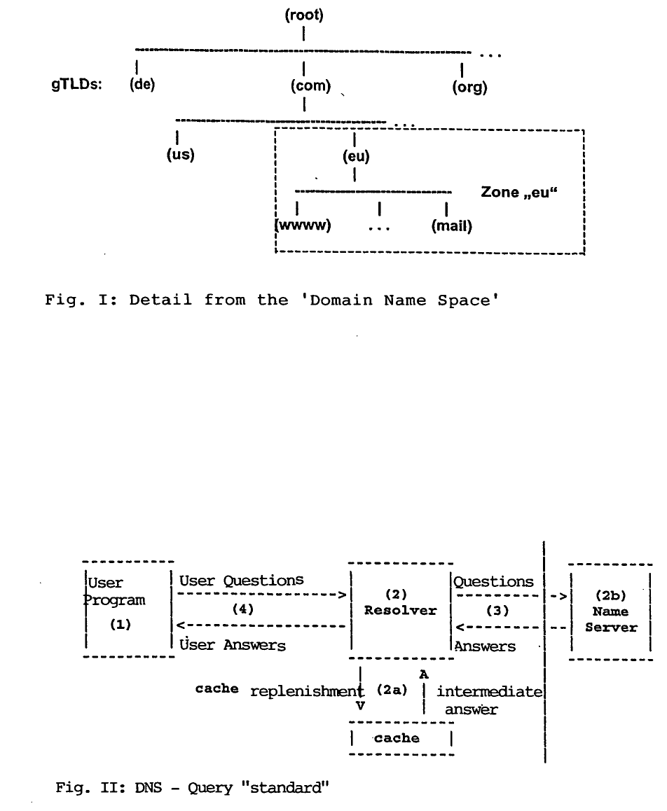

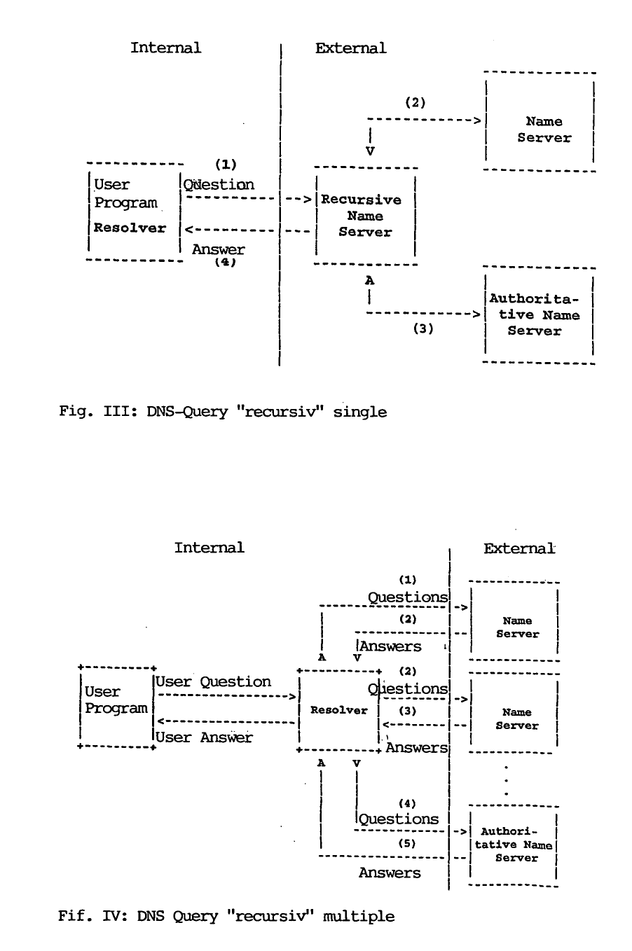

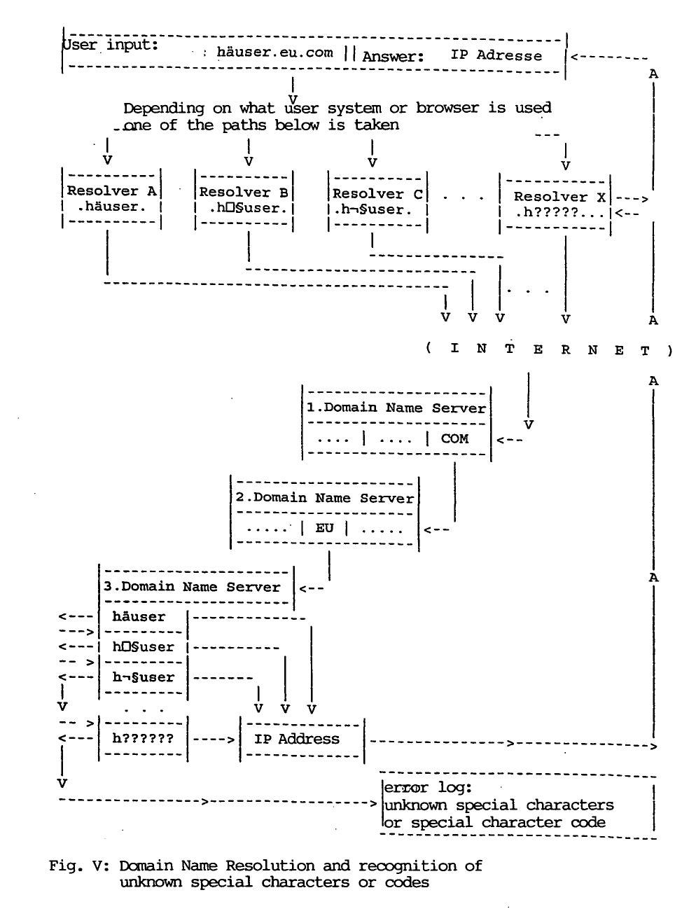

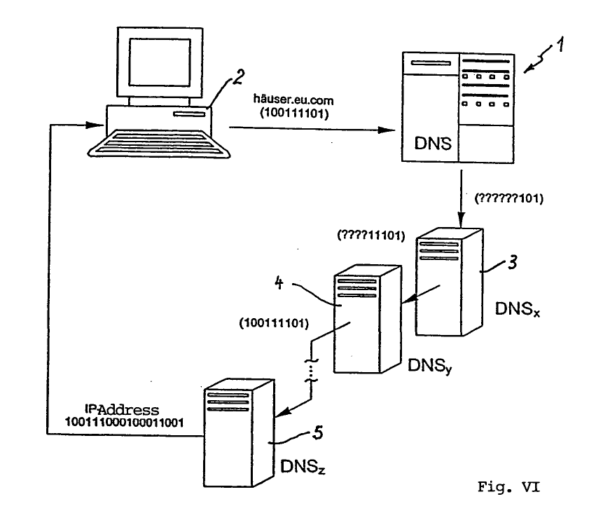

The invention relates to a method for providing internet addresses (domains) containing special characters in a computer network (internet).

When calling on an internet address, the respective internet addresses are entered in the browser following the recognition string http:// of the respective internet addressee in the form of letters, numbers, hyphens etc. in a subset of the so-called ASCII (American Standard Code for Information Interchange). With the aid of the Domain Name Server (DNS) located in the internet, the address is converted into a numeric key, called IP address (internet protocol address) to thereby start the contact routine.

The drawback is, that German umlauts, and other special characters such as for example an ampersand (“&”) and similar symbols can not be utilized. In the IT area and also in the internet they are generally replaced due to the limitation of the English language by vowel strings, that is, for example, “ü” by “ue”, and “ä” by “ae”. Thus, for example, the domain for a Mr. Müller in Germany is to be substituted by “mueller.de” as well as such firm names as “C&A” is substituted by “c-und-a.de”. Thus, for the admission of domains containing special characters an update would have to be carried out for all computers and programs that are used heretofore. However, this would mean serious intervention into the existing domain name system-architecture and from an economical viewpoint not practicable. One missing link in the information chain would be sufficient, to create a failure in the resolution of a domain containing a special character.

In a computer network, multiple computers are linked together. Each of the computers must be uniquely recognizable within the network. In the largest net to date, the internet, single computers (hosts) are uniquely identified by the so-called IP address.

Since it would be difficult for people to memorize many host-IP-addresses, a system was created whereby the IP address is assigned with a domain name. This system is the Domain Name System. So-called Domain Name Servers (DNS) provide information on the assignment of the domain names to IP-addresses. Within the Domain Name System, certain convention regarding domain names have been established. Accordingly, labels start with a letter, end with a letter or a number and contain letters, numbers or hyphens. Examples are: www.Mueller.de, www.Bochum.de, www.eu.com or www.sms.t-online.de.

The domain name space is established as a tree-like structure. Starting from the root, the top level domains generally follow (gTLDs) such as “de”, “com” or “org”. These are further divided into subdomains. The following illustration shows a small excerpt of the top level domain “com” with the sub domain “us” and “eu”. The leaves of the tree represent the single network resources (mostly hosts or routers) as seen in FIG. I for example www. or “mail”.

The DNS of the Domain Name Space administrate zones, which include a junction in the domain name space tree and all lower branches thereof. By means of the existence of name servers at various levels of the tree, the various zones of the DNS overlap. A DNS recognizes each of the next higher and next lower DNS.

Main object of the DNS is the assignment of IP-addresses to domain names and vice versa. A utility program (i.e. browser) need not implement such queries by itself. In most operating systems such a service is integrated. The user program can get the information by means of an operating system query. The actual query to the DNS is taken over by the resolver. In order to optimize their efficiency, all resolvers are provided with a local cache (intermediary storage) in order to be able to respond faster to multiple queries. A standard query is illustrated in FIG. II.

The sequence of a standard DNS query follows as illustrated herein:

(1) A user program has a domain name and wants to find out the assigned IP-address.

(2a) the user program sends a query to the resolver and expects an answer therefrom.

The resolver checks whether the answer is already located in the cache and in case it is, sends the answer.

(2b) If the answer is not yet found in the cache, then the resolver itself is sending a query to the DNS.

(3) The DNS sends the desired answer to the resolver.

(4) The resolver copies the answer in its cache and simultaneously sends it to the user program.

However, it is possible, that the first asked DNS provides no answer to the query, which was initiated by the resolver. In that case there are two possibilities:

The first queried DNS searches independently after further DNS, which can answer the query. In that case, nothing changes for the resolver, it simply waits, until it receives an answer from its “own” DNS. This type of query is called “recursive”. A “recursive” query is shown in FIG. III.

The sequence of a recursive DNS query is as follows:

(1) a query is sent from a certain resolver to a designated DNS. This query also contains the information that the query should also be carried out in a “recursive” manner.

(2) If the first queried DNS has not answer to the query, it transfers the query to another DNS, of which it assumes that an answer could be provided.

(3) If that DNS does not have an answer, the DNS tells that to the resolver and additionally indicates whether it knows a DNS that could possibly answer the query. This sequence can be repeated several times.

(4) At some point, the first DNS reaches a DNS that has an answer. In most cases, it is a so-called Authoritative Name Server.

(5) The answer to the query is then sent back to the resolver.

When the first DNS cannot provide a result to a query back to the resolver, another DNS is proposed, which is then required to answer the query. This scenario can repeat itself several rounds, until the resolver has finally asked a DNS that can provide he answer. This is illustrated in FIG. IV.

The WO 00/56035 discloses a method for the internationalization of domains. For this purpose an intermediary program is being provided, which must be downloaded from each of the respective browsers. This program converts the domain into an ASCII character sequence and then transmits it further. In order that the sequence can be identified by the Domain Name Server (DNS), the character sequence must be registered there. In order to register an internet domain which contains special characters, it must be inputted into the Unicode system and then converted into Latin letters. The conversion is called RACE which stands for Row-based ASCII-Compatible Encoding. Accordingly, the domain must be registered in the DNS in ASCII code, for example as bq-bhasutr.com in order to be recognized by the DNS. As a consequence, to admit such domains containing special characters worldwide, a change in all DNS would be required. Furthermore, then all queries would have to be led to a high performance iDNS server, since otherwise no conversion of the DNS that are located below the DNS could be realized.

WO 00/50966 proposes an intermediary server in the computer network, which can accept all queries, translates them and then transmits them to the DNS root server. It is contemplated that an identification is carried out which is similar to the method as afore-described. The IP address is transmitted back to the intermediary server, which then proceeds with the feedback to the user. An equivalent solution is also known from WO 99/40511.

All of the afore-stated solutions have in common that they require changes made to the existing system, that is, at the network elements for the browser in the from of auxiliary modules or changes in the DNS that are not burdened with special characters, so that the special characters in the domain name can be reliably converted.

Starting at the prior art, an object of the invention is to provide a simpler and more economic processing of character codes containing special characters and providing ingration into a DNS server architecture without the need for changing the requester-user system, as well as to provide an improved filtering mechanism within the scope of the method, which is cable of determining unconventional elements of the character code, typifying them and transmitting them for further processing.

This object is solved in accordance with a method according to claim 1.

In accordance with the method of the present invention, for providing internet addresses containing special characters in a computer network, the domains when called by the user are first converted into a character code by means of the currently existing resolver. This character code is then converted to a first DNS, the so-called root server. The transformed character codes consist of a sequence of binary or hexa-decimal digits. If the character code cannot be identified by the first DNS, then it is send to at least one additional DNS which determines, by means of a sequential comparative operation, the correspondingly known numerical key (IP-Address) which is then retransmitted to the user.

If the character code from the first DNS can be partially decoded, a further DNS is then contacted conducting further decoding. In this sequence, additional DNS can be contacted until a complete decoding of the called-on internet address is realized and is finally transmitted to the user as an IP address.

In accordance with the present invention, an internet address, for example häuser.eu.com would be decoded from the end to the start (see also the representation in FIGS. V and VI). The first contacted DNS recognizes the ending “.com”. The DNS then transmits the query in the next step, that is, a further DNS is contacted that recognizes the partial key “eu”. The remaining partial key of the IP address could not be identified by a conventional DNS and would represent a nonsensical number sequence for purposes of the network technology.

This nonsensical number sequences is being decoded on a DNS in a sequential comparative operation and here converted as an unconventional query into a conventional response from a number sequence. Thus, the character code is assigned by means of the sequential comparative operation to a correct IP address and fed back to the user, whereupon the user then arrives at the desired internet page.

The domain name resolution with special character use and recognition of unknown special characters respectively explanation of the coding is explained through FIG. V.

A user queries the domain “häuser.eu.com” through input into the browser. The domain containing the special character “ä” is then converted into a character depending upon the browser's respective resolver it uses, for example into the character code “.h □§user”. The query is then fed to the DNS via the internet. The DNS recognizes the ending “.com”. In the second DNS a further decoding of the character code is carried out, whereby the partial key “eu” is being decoded. Finally in the third DNS a complete decoding of the binary sequence of the character code is carried out through a sequential comparative operation. The third DNS then returns the correct IP-address to the poser of the query, respectively the user. In case the third DNS is unable to decode the queried domain, it is possible to enter the domain name into the error log. By means of the error log, the provider of the third Domain Name Server can then chose appropriate action.

A domain containing special characters is defined as a domain which contains characters that are outside the area of “A/a” to “Z/z”, “0” to “9” and are outside the separation symbols “., -, @”. All international symbols are deemed to be special characters even if they are falling into the area of the ASCII “A/a” to “Z/z” respectively “0” to “9” but which are not so denoted in the browser of origin, that they are not represented as such to the requester.

The sequential comparison operations are determined according to a special assignment table, which, in accordance with the present invention, contains the keys for the various character codes generated for the browser resolver and wherein the assignment table is continuously screened for sequences that are deposited there and which are compared to those from the character codes generated by the browser/resolver of the user.

Since the browser, respectively the resolver are converting one and the same domain containing the special character into single- or multiple character sequences, such character codes containing single- or multiple characters could not be recognized by the DNS as heretofore utilized. An essential advantage of the invention is, no bytewise association or segmentation of the generic character codes are required for a special character, rather the special characters containing domain respectively the character code, is recognized as a whole that is in full length by means of the sequential comparative operation. Due to the assignment table listing the character codes generated by the various browsers and/or resolvers as a whole, such domains can be recognized in the same manner as the conventional domains and can be considered in a domain name server chain.

A further advantage is that by means of the sequential comparative operation, the DNS which resolves the domain containing special characters is only addressed when indeed special characters are present in the domain to thereby also unburden the DNS that resolves the domain containing special characters.

If the method of the present invention were applied with a DNS which is incapable of decoding special characters, an error message would be shown to the operator of the Domain Name Server and would then be entered into an error log.

By means of the error log, the operator would have to sort manually the corrected input that was not yet correctly coded and if applicable enter it into the assignment table of the DNS.

The determination of the correct domain entry into the assignment table was realized through the manual text input in the filed “http://. . . ” in the browsers of the various manufacturers. It was then examined which of the character codes the browser is transmitting and which IP-addresses corresponds to this character code. A manual association of the character code to the corrected address then follows, wherein the character code is then entered into the assignment table of the DNS. This has to be done for each typical browser family, respectively for each operating system, so that at least one, in the worst case, an additional entry had to be made into the assignment table of the DNS. This manual method is considerably improved by an automated method as is recited through the features in patent claim 2. Independent protection is thus claimed for these features.

Principal goal is to process the assignment table either in a time-delayed manner or also online with the proviso that obvious non-recognition errors are to be recognized as possible new characters codes and/or new unknown browsers respectively domain name queries and if applicable a correction entered into the assignment table of the DNS automatically. Thereby, future queries of the same requester are to be correctly resolved, that is, they are assigned to the right IP address and then transmitted as feedback.

It is contemplated that within a determined period of time unconventional special character codes that are directed to a DNS are evaluated and stored as correct queries of IP addresses and by means of an algorithm, the repetitive unconventional elements of the character codes determined and sorted. Thereafter, the sorted typified elements of the character code serve as a basis for recognition of character codes with identical and similar elements through the sequential comparative operations.

Through the collection of unconventional character codes, that is character code that do no conform to the convention heretofore employed within a time window and the fiction that the unconventional character codes are to be evaluated as correct queries of IP addresses, there is the possibility to analyze the data in a purposeful way by means of an algorithm and especially to determine and typify repetitive unconventional elements.

The typification of the code elements can be realized in accordance with one or more of the criteria. At first, it will be examined whether the element of the character code can be assigned with an operating system, in particular, a browser and/or a resolver of the host. All address queries of the various browsers (requesters) are being sorted as correct and assigned with the IP address as logged in the assignment table. One or more logs can be entered into the assignment table, if the various requesters are different from each other.

In accordance with patent claim 1, besides the requester-specific features or anomalies, that is local or national special features should be recognized. Even though the browsers are being programmed in a programming language, but at the user's juncture, they are delivered in various character sequences. Sometimes the browsers are even multilingual and are provided in various dialects. In accordance with patent claim 1 section b, during typification, it will be examined if a certain character sequence, which influences the character code, is the source for the unconventional element of the character code.

Furthermore, in accordance with the features of patent claim 1 section c, it is possible to examine whether certain parameters of the operating system influencing the character codes are the source for the unconventional elements of the character code. Each parameter of the operating system, respectively the browser, can be varied by the server. For example, it is possible for a user to use different character sequences. As a result, the same requester, in particular a browser, can send out different parametric specific character codes which can be learned by the DNS and logged into the assignment table for association with the correct IP address.

In some older operating systems, characters are limited to those that are admitted by the operating system. Other characters, in particular special characters are simply suppressed. This suppression of characters principally can be also evaluated as valid character code. The character code thus no longer comprises special characters but it must be possible to associate these character codes with the correct IP address by means of the remaining characters.

Thus, it is possible according to the features of patent claim 1 section d, to test whether an operating system that influences the character codes is utilized with the host in order to realize recognition and learning of the operating specific changes of the character codes.

Moreover, it is also possible that the unconventional elements of the character codes are traced back to the input location and/or the transmission path. According to the feature of patent claim 1 section e, testing and typifying along those lines should be realized. In particular through suppressing and /or adding characters or through falsification through intended or unintended masking of single bits during transmission it is possible that the character code is being changed and that the receiving DNS cannot assign an IP address. By varying the input location in the network, in particular from different continents, it can be suitably realized that as many DNS as possible can modify the character code. Due to recognition and typification of modifications an adjustment of the assignment table of a DNS is possible.

Advantageously, the results of the typification are utilized as a basis for an automatic actualization of the assignment table of the DNS.

Besides the methods as described in patent claim 1 which essentially comprises two temporal sections, namely a first phase of data gathering and a second phase of data evaluation, mechanisms are provided in accordance with patent claim 2 to 9, that activate an automatic selection method and which can be potentially carried our in real time.

Thereby, the received character codes are being treated, in particular they are filtered, such that the standard characters of the character codes, in particular, the alphanumeric characters “A/a” to “Z/z”, “0” to “9” and the separation characters “-, ., @” are the basis for a sequential comparative operation of the assignment table (patent claim 2). Essential is that correspondingly filtered character codes are logged into the assignment table so that the unique assignment of a newly posed filtered query can be realized by means of a sequential comparative operation

In accordance with the features of patent claim 6, it is provided that when a filtered character code can be uniquely assigned to an IP address, the assignment is carried out and the IP address is transmitted to the requester.

Since a unique assignment of the filtered character code is thus possible, a filtering of the character coded for the next query is superfluous, so that the features of claim 4 provide that the unfiltered character code is entered into the assignment table. Thus, this saves the filtering operation so that a faster assignment of the character code to the entry in the assignment table is realized.

The feature of patent claim 5 provide that a variable value computation is assigned to each IP address in the assignment table. There is no absolute requirement that the value computation of an IP address is variable, but is can be set higher or lower depending on various influencing factors. An important factor is the call frequency of an IP address (patent claim 6). While the number of access to an IP address is generally registered at the internet service providers, it is conceivable to register the frequency of access to a certain IP address in the DNS and to assign a corresponding value to the IP address in the assignment table.

Thus, it is possible that a filtered character code cannot be assigned unequivocally to an IP address in the assignment table of the host, that is, not all possible assignments for an online election can be transmitted to the requester (patent claim 7). With respect to the value sequence, this on-line selection can oriented itself according to the possible assignments, which were transmitted to the requester of the DNS (patent claim 8). The IP address with the highest value, in particular the one with the most calls is therefore entered in first place in the assignment table, as the probability is greatest that the user/requester will also call the address. The selection of the user is in accordance with a protocol of the DNS, whereby the correct IP address can be automatically, especially on-line assigned to the character code. At the next call for the domain name, the correct website with the correct IP address can be obtained without detours via the selection mark imitated by the DNS by means of the protocol on part of the host computer/requester.

According to patent claim 9, it is optionally possible that in case where it is not possible to unequivocally assign the filtered character code to an IP address, the character code is assigned that IP address, which is ranked highest in value. This type of assignment is particularly simple and leads quickly to results. Whether that result is satisfactory to the requester depends on whether the requester actually intended to call up the IP address having the highest value. This method is particularly useful when IP addresses having vastly differing values are in the assignment table, so that it is overwhelmingly probable that the IP address with the highest value is called.

According to the features in patent claim 10, with large numbers of assignments or assignments that have essentially the same value it is advantageous when one of the methods as embodied in patent claims 5 to 10 is initiated by an automatic decision routine. This should be dependent on the number of possible assignments and/or when a pre-determined number has been exceeded and/or when a value difference has been exceeded. For example, if five addresses having the same value are present in the assignment table, it is practicable to transmit to the host/requester all possible assignments for an on-line selection. If only two entries are present in the assignment table, wherein one of the entries has a high value and another entry has a diminishingly small value, it is preferred to proceed in accordance with the method of claim 9, so that the character code is assigned that IP address with the higher value. Thus, it is negligible how and in what from the value has been established.

If it is not possible to assign character codes that are typified through sequential comparative operations and/ or typification according to one of the methods as recited in patent claims 1 through 10, it is possible within the scope of the invention that the character code is being fed to an error log for manual post treatment.

Subject of patent claim 11 is that a character code, after the assignment through DNS, is stored intermittently in the cache of the requester. This relieves the DNS which resolves the special characters and supports an expedited access by the requester to the desired domain. Thus, no new contact of the respective Domain Name Server (cf. 3 Domain Name Server in FIG. V) is required when renewing a dial-up.

The method and also the computer network based thereon are technically generalized and represented schematically according to FIG. VI. The computer network comprises a first Domain Name Server (1) which is contacted when called for an internet address through the user of computer (2). The first DNS 1 is able to identify a partial key from the character code generated through the internet-address, namely the ending “.com”. The call is then transmitted with the partial key here represented by (?????101) to the DNSₓ (3). The DNS is capable to recognize the partial key “.eu.com” corresponding to partial key (?????11101). This partial key is then transferred to DNS_{y} (4), where another decoding is carried out. At the end of the chain, the DNS_{z} (5) is contacted, which represents the authoritative name server whereby with the aid of the sequential comparative operation it is pointed to the correct IP address. The now determined and known numeric key (IP address) is being transferred to the user. The user now reaches the called-upon internet page.

In accordance with the invention, internet addresses can be utilized that comprise special characters without the need for assigning additional transformation modules to the domain name root server or to the requesters, as for example, additional transformation module to the browser or that every domain has to be stored. By means of the chain decoding, only a portion must be decoded in the DNSz (5) by means of the tree structure, which could not be identified from the upstream Domain Name Servers 1, 3 and 4.

1. Method for providing internet addresses (domains) containing special characters in a computer network (internet) wherein the domains, when being called-up by a user, are first converted into a character code, which is then transmitted to a first Domain Name Server (DNS) (1) and in case the character code cannot be identified by the first DNS (1), is being transferred from the first DNS (1) to at least one further DNS (5) whereby the character code can be decoded by means of a sequential comparative operation, and in case the character code is partially decoded by the first DNS (1), at least one further DNS (3-5) is contacted, which carries out further decoding, whereby the character code is assigned a known numeric code (IP address) and being retransmitted to the user, wherein the sequential comparative operation recognizes by means of the assignement table the codes for the character codes generated by the various browsers and within a pre-determined period of time an unconventional character code directed to a DNS is being evaluated as correct queries of IP addresses and stored, whereby repetitive unconventional elements in the stored character code can be determined and typified via an algorithm and thereafter the typified elements of the character code serving as a basis for the recognition of character codes with identical or similar elements in the sequential comparative operation, whereby the typification of the code-elements is carried out according to one or more of the following criteria:
a) examining, whether the element of the character code can be assigned an application program, in particular a browser and/or resolver of the requester;
b) examining whether a specific code sequence of the application program influencing the character codes can be the source for the conventional elements of the character code;
c) examining whether specific parameters of the application program influencing the character code can be the source for the conventional elements of the character code;
d) examining whether an operating system influencing the character code is used on the host/requester;
e) examining whether an input location and/or transmission path which influences the character code is the source for the unconventional elements of the character code, and
wherein the results of the typification serve as a basis for an automatic actualization of the assignment table of the DNS.

2. Method according to claim 1, wherein the character code received by a DNS (1-5) is filtered with respect to the special characters, whereby the standard characters in the character code, in particular, the alphanumeric signs “A” to “Z”, “0” to “9” and “-”, are exclusively the basis for a subsequent sequential comparative operation of the assignment table.

3. Method according to claim 2, characterized in that in an unequivocal assignment of the filtered character code to an IP address of the assignment table, the assignment is carried out and the IP address is being transmitted to the requestor.

4. Method according to claim 3, characterized in that with unequivocal assignment of the filtered character code, the unfiltered character code is being entered into the DNS.

5. Method according to one of claims 1 to 4, characterized in that each IP address in the assignment code is assigned a variable value.

6. Method according to claim 5, characterized in that the frequency of a call-up of an IP address is registered in the assignment table and a call frequency assigned a corresponding value.

7. Method according to claim 2, characterized in that when an assignment which cannot be unequivocal for the filtered character code to an IP address of the assignment table, all possibly assignments are transmitted to the requester for on-line selection.

8. Method according to claim 7, characterized in that all possible assignments are listed according to their value in the DNS.

9. Method according to claim 5, characterized in that in case no unequivocal assignment of the filtered character code can be made to an IP address, the character code is then assigned to that IP address having the highest value.

10. Method according to one of claims 5 to 9, characterized in that depending upon the number of all possible assignments when exceeding a predetermined number and/or value difference, one or more of the features of claim 5 to 9 will be automatically carried out.

11. Method according to one of claims 1 to 10 characterized in that after assignment through the DNS, the character code is intermittently stored in the cache of the requester.
